(19) United States
(12) Patent Application Publication
(10) Pub. No.: US 2008/0197524 A1
(43) Pub. Date: Aug. 21, 2008

(54) Thermoformable Melamine/Formaldehyde-Based Foams Exhibiting Low-Formeldehyde Emission

(76) Inventors: Horst Baumgartl, Mainz (DE); Jens-Uwe Schierholz, Bensheim (DE)

Correspondence Address: Connolly Bove Lodge & Hutz LLP, 1875 Eye Street, NW, Suite 1100, Washington, DC, 20006, US

(21) Appl. No.: 11/917,481

(22) PCT Filed: Jun. 12, 2006
(86) PCT No.: PCT/EP2006/063082

§ 371 Date: Dec. 13, 2007

(30) Foreign Application Priority Data
Jun. 14, 2005 (DE) 102005027552.4

(51) Int. Cl. C08J 9/00

(52) U.S. Cl. 264/54

(57) ABSTRACT

A process for the production of foams by heating with foaming and crosslinking of a mixture comprising a melamine/formaldehyde (MF) precondensate, a curing agent and a blowing agent, a formaldehyde scavenger being added prior to the heating, and foams based on melamine/formaldehyde resins having a low formaldehyde emission and the use thereof for the production of shaped articles by thermoforming.

The invention relates to a process for the production of foams based on melamine/formaldehyde resins having a low formaldehyde emission and the use for the production of shaped articles by thermoforming.

Open-cell resilient foams based on melamine/formaldehyde resins and processes for their production by heating with hot air, steam or microwave radiation with foaming and crosslinking of a blowing agent-containing solution or dispersion of a melamine/formaldehyde precondensate are known and are described, for example, in EP-A 17672 and EP-A 37470.

Foams based on formaldehyde resin emit small amounts of formaldehyde. The formaldehyde emission increases with increasing temperature and humidity. WO 01/94436 therefore describes a process for the production of foams based on the melamine/formaldehyde condensate having a low formaldehyde emission, an MF precondensate having a molar ratio of melamine to formaldehyde of more than 1:2 being used. In order to achieve very low formaldehyde emissions, the foam must be heated for a further 30 minutes at 220° C. after drying. After the heating, however, the foams have cured and are no longer thermoformable.

EP-A 1 505 105 therefore describes a process for the production of shaped articles from melamine/formaldehyde foams having a low formaldehyde emission, in which the foam is heated at temperatures of from 100 to 160° C. after the production and before the thermoforming.

It was an object of the invention to provide a process for the production of melamine/formaldehyde foams which are thermoformable and at the same time have low formaldehyde emissions even before the thermoforming to give shaped articles.

Accordingly, a process for the production of foams by heating with foaming and crosslinking of a mixture comprising a melamine/formaldehyde (MF) precondensate, a curing agent and a blowing agent was found, a formaldehyde scavenger being added prior to the heating.

Suitable formaldehyde scavengers are, for example, urea, substituted ureas, alkyl- or aryl-substituted melamine, urethanes, carboxamides, dicyandiamide, guanidine, sulfurylamide, sulfonamides, aliphatic amines, glycols or phenols. The formaldehyde scavenger is as a rule added in amounts of from 2 to 20%, preferably from 5 to 15%, based on the melamine/formaldehyde (MF) precondensate.

The process according to the invention starts from a melamine/formaldehyde precondensate. Melamine/formaldehyde precondensates may comprise up to 50, preferably up to 20, % by weight of other precursors of thermosetting plastics in addition to melamine, and up to 50, preferably up to 20, % by weight of other aldehydes in addition to formaldehyde, incorporated in the form of condensed units. An unmodified melamine/formaldehyde condensate is particularly preferred. Examples of suitable precursors of thermosetting plastics are: alkyl- and arylalkyl-substituted melamine, urea, urethanes, carboxamides, dicyandiamide, guanidine, sulfurylamide, sulfonamides, aliphatic amines, glycols, phenol and derivatives thereof. Aldehydes which may be used are, for example, acetaldehyde, trimethylolacetaldehyde, acrolein, benzaldehyde, furfurol, glyoxal, glutaraldehyde, phthalaldehyde and terephthalaldehyde. Further details concerning melamine/formaldehyde condensates are to be found in Houben-Weyl, Methoden der organischen Chemie, Volume 14/2, 1963, pages 319 to 402.

The molar ratio of melamine to formaldehyde is as a rule less than 1:1.0 and is preferably between 1:1.2 to 1:4.0, in particular from 1:1.3 to 1:1.8. According to EP-B 37470, the melamine resins advantageously comprise sulfite groups incorporated in the form of condensed units, which may be effected, for example, by addition of from 1 to 20% by weight of sodium bisuffite during the condensation of the resin. It has now been found that a relatively high sulfide group content with constant melamine-to-formaldehyde ratio results in a higher formaldehyde emission of the foam. The precondensate used should therefore comprise virtually no sulfite groups, i.e. the sulfite group content should be less than 1%, preferably less than 0.1% and in particular zero.

The addition of an emulsifier or of an emulsifier mixture is required for emulsifying the blowing agent and for stabilizing the foam. Anionic, cationic and nonionic surfactants and mixtures thereof may be used as the emulsifier.

Suitable anionic surfactants are diphenylene oxide sulfonates, alkane- and alkylbenzenesulfonates, alkylnaphthalenesulfonates, olefin sulfonates, alkyl ether sulfonates, fatty alcohol sulfates, ether sulfates, alpha-sulfo-fatty acid esters, acylaminoalkanesulfonates, acylisothionates, alkyl ether carboxylates, N-acylsarcosinates, alkyl phosphates and alkyl ether phosphates. Nonionic surfactants which may be used are alkylphenol polyglycol ethers, fatty alcohol polyglycol ethers, fatty acid polyglycol ethers, fatty acid alkanolamides, EO/PO block copolymers, amine oxides, glyceryl fatty esters, sorbitan esters and alkylpolyglucosides. Cationic emulsifiers which may be used are alkyltriammonium salts, alkylbenzyldimethylammonium salts and alkylpyridine salts. The emulsifiers are preferably added in amounts of from 0.2 to 5% by weight, based on the resin.

In order to produce a foam from the melamine resin solution, said solution must comprise a blowing agent, the amount depending on the desired density of the foam. In principle, both physical and chemical blowing agents can be used in the process according to the invention. Examples of possible physical blowing agents are: hydrocarbons, halogenated, in particular fluorinated, hydrocarbons, alcohols, ethers, ketones and esters in liquid form or air and CO₂ as gases. Suitable chemical blowing agents are, for example, isocyanates as a mixture with water, CO₂ being liberated as the effective blowing agent, and furthermore carbonates and bicarbonates as a mixture with acid, which likewise produce CO₂, and azo compounds, such as azodicarbonamide. In a preferred embodiment of the invention, from 1 to 40% by weight, based on the resin, of a physical blowing agent having a boiling point of from 0 to 80° C. are added to the aqueous solution or dispersion; in the case of pentane, it is preferably from 5 to 15% by weight.

Curing agents used are acidic compounds which catalyze the further condensation of the melamine resin. The amounts are from 0.01 to 20, preferably from 0.05 to 5, % by weight, based on the resin. Inorganic and organic acids are suitable, e.g. hydrochloric acid, sulfuric acid, phosphoric acid, nitric acid, formic acid, acetic acid, oxalic acid, toluenesulfonic acids, amidosulfonic acids and acid anhydrides.

The aqueous solution or dispersion is preferably free of further additives. For some purposes, however, it may be advantageous to add up to 20% by weight, preferably less than 10% by weight, based on the resin, of conventional additives, such as dyes, flameproofing agents, UV stabilizers, agents for reducing the combustion gas toxicity or for promoting carbonization. Since the foams are generally open-pore foams and can absorb water, it may be necessary for some intended uses to add water repellents in amounts of from 0.2 to 5% by weight. For example, silicones, paraffins, silicone and fluorine surfactants, hydrophobic hydrocarbon surfactants, silicone and fluorocarbon emulsions are suitable.

The concentration of the melamine/formaldehyde precondensate in the mixture of precondensate and solvent can vary within wide limits of from 55 to 85, preferably from 63 to 80, % by weight. The preferred viscosity of the mixture of precondensate and solvent is from 1 to 300° dPas, preferably from 5 to 2000 dPas.

The additives are homogeneously mixed with the aqueous solution or dispersion of the melamine resin, it also being possible, if appropriate, to force the blowing agent in under pressure. However, it is also possible to start from a solid, for example spray-dried, melamine resin and then to mix this with an aqueous solution of the emulsifier, the curing agent and the blowing agent. The mixing of the components can be carried out, for example, in an extruder. After the mixing, the solution or dispersion is discharged through a nozzle and heated directly thereafter and thereby foamed.

The heating of the blowing agent-containing solution or dispersion can in principle be carried out—as described in EP-B 17671—by hot gases or high-frequency irradiation. However, the required heating is preferably carried out by ultra-high-frequency irradiation according to EP-B 37470. In the case of this dielectric radiation, it is possible in principle to employ microwaves in the frequency range from 0.2 GHz to 100 GHz. Frequencies of 0.915, 2.45 and 5.8 GHz are available for industrial practice, 2.45 GHz being particularly preferred. A radiation source for dielectric radiation is the magnetron, irradiation with a plurality of magnetrons simultaneously also being possible. It should be ensured that the field distribution is as homogeneous as possible during the irradiation.

The irradiation is expediently carried out in a manner such that the power consumption of the solution or dispersion is from 5 to 200, preferably from 9 to 120, kW, based on 1 kg of water in the solution or dispersion. If the power absorbed is lower, foaming no longer takes place and the mixture merely cures. If the procedure is effected within the preferred range, the mixture foams all the more rapidly the greater the power consumption. Above about 200 kW per kg of water, the foaming rate no longer increases substantially.

The irradiation of the mixture to be foamed is effected immediately after it has emerged from the foam-generating nozzle. The mixture which foams as a result of temperature increase and evaporation of the blowing agent is applied to revolving belts which form a rectangular channel for shaping the foam.

After their production, the foams according to the invention are subjected to a thermal treatment. They are heated as a rule for from 1 to 180 min, preferably from 5 to 60 min, at temperatures of from 100 to 300° C., in particular from 150 to 250° C., water, blowing agent and formaldehyde being substantially removed.

The resilient foams produced according to the invention and preferably comprising virtually no sulfite groups have a density of from 5 to 50 gl⁻¹.

The foams can—as described in EP-B 37470—be heated and molded in order to improve their performance characteristics.

The foams can be produced as slabs or webs having a height up to 2 m or as foam sheets having a thickness of a few mm. The preferred foam height (in the direction of foaming) is from 50 cm to 150 cm when microwaves of 2.45 GHz frequency are used. All desired slab or sheet thicknesses can be cut out from such foam webs. The foams can be provided with or laminated with cover sheets on one or both sides, for example with paper, board, glass surfacing mats, wood, plasterboards, metal sheets or metal foils, or plastic films which, if appropriate, may also be foamed.

The main field of use of the foams produced according to the invention is for heat and sound insulation of buildings and parts of buildings, in particular of partitions, but also of roofs, facades, doors and floors; furthermore for heat and sound insulation of engine compartments and interiors of vehicles and aircraft and for low-temperature insulation, for example of cold rooms, oil tanks and liquid gas containers. Further fields of use are the use as insulating wall cladding and as insulating and shock-absorbing packaging materials. Owing to the great hardness of crosslinked melamine resins, the foams can also be used for slightly abrasive cleaning, abrasive and polishing sponges. The open-cell structure of the foam additionally permits the absorption and storage of suitable cleaning agents, abrasives and polishes in the interior of the foams. The sponges can also be provided with a hydrophobic and oleophobic treatment for special cleaning tasks. Owing to the extremely low formaldehyde emissions in comparison with the M/F foams offered on the market to date, the foams according to the invention can also be used in the hygiene sector, for example in the form of thin nonwovens, as wound dressings or as part of diapers and incontinence products.

The parts and percentages stated in the examples are based on weight.

### EXAMPLE 1

70 parts of a spray-dried melamine/formaldehyde precondensate (molar ratio 1:1.6) and 5.25 parts of urea are dissolved in water. 3% of formic acid, 2% of a fatty alcohol polyglycol ether and 10% of pentane, based in each case on resin, are added to this resin solution. Vigorous stirring is effected, after which foaming is carried out in a polypropylene foaming mold by introduction of microwave energy at 2.54 GHz by radiation.

The formaldehyde scavenger has the greatest effect during the heating at a temperature in the range from 100 to 160° C. At this temperature, the foam still has not completely cured, so that it remains thermoformable and nevertheless has a formaldehyde emission, measured according to DIN 55666, of 0.1 ppm or less. The formaldehyde emission of the foam according to the invention is therefore below the limit of 0.1 ppm stipulated in §1 of the Regulation on Prohibited Chemicals.

### EXAMPLES

After heating at 110° C., the foam emits 0.08 ppm of formaldehyde, determined according to DIN 55666. The foam is thermoformable and the formaldehyde emissions are below the limit of the Regulation on Prohibited Chemicals.

### EXAMPLE 2

Example 1 was repeated, except that the heating was effected at 220° C. and a formaldehyde emission of 0.3 ppm, according to DIN 55666, was determined. The foam is not thermoformable.

### Comparative Experiment

Example 1 was repeated, no urea being added. After heating at 110° C., the foam emits 0.42 ppm of formaldehyde, determined according to DIN 55666. The foam is thermoformable but the formaldehyde emissions are above the limit of the Regulation on Prohibited Chemicals.

1. A process for the production of foams by heating with foaming and crosslinking of a mixture comprising
a melamine/formaldehyde (ME) precondensate, a curing agent and a blowing agent,
wherein urea, substituted ureas, alkyl- or arylsubstituted melamine, urethanes, carboxamides, dicyandiamide, guanidine, sulfurylamide, sulfonamides, aliphatic amines or glycols in amounts of from 2 to 10% by weight, based on the melamine/formaldehyde (MF) precondensate, are added as formaldehyde scavengers prior to the heating.

2. The process according to claim 1, wherein the mixture is used in the form of an aqueous solution or dispersion comprising from 55 to 85% by weight of melamine/formaldehyde (MF) precondensate.

3. The process according to claim 1, wherein the molar melamine/formaldehyde ratio of the precondensate is in the range from 1:1.3 to 1:4.

4. The process according to claim 1, wherein from 0.01 to 20% by weight, based on the melamine/formaldehyde (ME) precondensate, are used as the curing agent.

5. The process according to claim 1, wherein a physical blowing agent having a boiling point of from 0 to Sot is used in amounts of from 1 to 40% by weight, based on the melamine/formaldehyde (ME) precondensate.

6. The process according to claim 1, wherein, after the foaming and crosslinking, the foam is heated at a temperature in the range from 100 to 160° C.

7. The process according to claim 2, wherein the molar melamine/formaldehyde ratio of the precondensate is in the range from 1:1.3 to 1:4.

8. The process according to claim 2, wherein from 0.01 to 20% by weight, based on the melamine/formaldehyde (ME) precondensate, are used as the curing agent.

9. The process according to claim 3, wherein from 0.01 to 20% by weight, based on the melamine/formaldehyde (ME) precondensate, are used as the curing agent.

10. The process according to claim 2, wherein a physical blowing agent having a boiling point of from 0 to Sot is used in amounts of from 1 to 40% by weight, based on the melamine/formaldehyde (ME) precondensate.

11. The process according to claim 3, wherein a physical blowing agent having a boiling point of from 0 to Sot is used in amounts of from 1 to 40% by weight, based on the melamine/formaldehyde (ME) precondensate.

12. The process according to claim 4, wherein a physical blowing agent having a boiling point of from 0 to Sot is used in amounts of from 1 to 40% by weight, based on the melamine/formaldehyde (ME) precondensate.

13. The process according to claim 2, wherein, after the foaming and crosslinking, the foam is heated at a temperature in the range from 100 to 160° C.

14. The process according to claim 3, wherein, after the foaming and crosslinking, the foam is heated at a temperature in the range from 100 to 160° C.

15. The process according to claim 4, wherein, after the foaming and crosslinking, the foam is heated at a temperature in the range from 100 to 160° C.

16. The process according to claim 5, wherein, after the foaming and crosslinking, the foam is heated at a temperature in the range from 100 to 160° C.
